(19) United States
(12) Patent Application Publication
(10) Pub. No.: US 2008/0293606 A1
(43) Pub. Date: Nov. 27, 2008

(54) Organosilicon Compound-Containing Compositions

(75) Inventors: Holger Rautschek, Nuenchritz (DE); Christian Fehn, Nuernberg (DE); Heinz Hoffmann, Bayreuth (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/094,764

(22) PCT Filed: Nov. 15, 2006
(86) PCT No.: PCT/EP06/68488

§ 371 Date: May 22, 2008

(30) Foreign Application Priority Data
Nov. 23, 2005 (DE) 10 2005 005 839.9

(51) Int. Cl. C11D 3/37; C11D 17/08

(52) U.S. Cl. 510/221; 510/405; 510/338; 524/588

(57) ABSTRACT

Defoamer compositions contain a carrier oil and at least one particulate filler of less than 40°, measured with water as a surrounding phase. The defoamers are surprisingly more active than prior art defoamers.

The invention relates to compositions which are based on organosilicon compounds and particulate fillers and are notable for selected contact angles, to processes for their production and to their use as defoamers.

In many liquid systems, especially aqueous systems, which comprise surface-active compounds as desired or else undesired constituents, foam formation can cause problems when these systems are brought into more or less intensive contact with gaseous substances, for example in the aeration of wastewater, in the intensive stirring of liquids, in distillation, washing or dyeing processes, or in filling operations.

This foam can be controlled by mechanical means or by the addition of defoamers. Siloxane-based defoamers have been found to be particularly useful. Defoamers based on siloxanes are prepared, for example, according to DE-B 15 19 987 by heating hydrophilic silica in polydimethylsiloxanes. The use of basic catalysts allows the activity of such defoamers to be improved, as disclosed, for instance, in DE-A 17 69 940. One alternative is the distribution of hydrophobized silica in a polydimethylsiloxane, for example according to DE-A 29 25 722. In this context, it is essential for the activity that the silica has been sufficiently hydrophobized and is no longer wetted by water, but rather only by water-methanol mixtures when they contain more than 50% methanol.

The need for good hydrophobization of a silica used in antifoams is also emphasized in EP-A 967252. The significance of the hydrophobicity of the particles for the defoaming action is described by Kobayashi (J. Colloid Interface Sci., 156(2), 294-8 1993) and Marinova et al. (Langmuir, 18(9), 3399-3403 2002).

However, the known defoamer formulations in highly foaming surfactant-rich systems do not always have a sufficiently long-lasting activity.

The invention provides compositions comprising at least one carrier oil and at least one particulate filler, with the proviso that the contact angle of the carrier oil with respect to the filler, measured with water as the surrounding phase, is less than 40°, preferably less than 30°, more preferably less than 20°, especially from 5° to 15°.

The inventive compositions are preferably those comprising

(A) at least one organosilicon compound selected from (A1) organopolysiloxanes composed of units of the formula

Rₐ(R¹O)_{b}SiO_{(4-a-b)/2} (I)

in which
R may be the same or different and is a hydrogen atom or a monovalent, optionally substituted, SiC-bonded hydrocarbon radical,
R¹ may be the same or different and is a hydrogen atom or a monovalent, optionally substituted hydrocarbon radical,
a is 0, 1, 2 or 3,
b is 0, 1, 2 or 3,
with the proviso that the sum of a+b is ≦3 and the sum of a+b in at least 50% of all units of the formula (I) in the organosilicon compound (A1) is equal to 2,
and
(A2) organopolysiloxane resins composed of units of the formula

R²_{c}(R³⁰)_{d}SiO_{(4-c-d)/2} (II)

in which
R² may be the same or different and is a hydrogen atom or a monovalent, optionally substituted, SiC-bonded hydrocarbon radical,
R³ may be the same or different and is a hydrogen atom or a monovalent, optionally substituted hydrocarbon radical,
c is 0, 1, 2 or 3 and
d is 0, 1, 2 or 3,
with the proviso that the sum of c+d is ≦3 and the sum of c+d in less than 50% of all units of the formula (II) in the organopolysiloxane resin (A2) is equal to 2,
where component (A) has a viscosity at 25° C. of 5 to 5 000 000 mm²/s, preferably 50 to 50 000 mm²/s,
and
(B) at least one particulate filler,
with the proviso that the contact angle of component (A) relative to component (B), measured with water as the surrounding phase, is less than 40°.

In the context of the present invention, the term “organopolysiloxanes” shall encompass polymeric, oligomeric and also dimeric siloxanes.

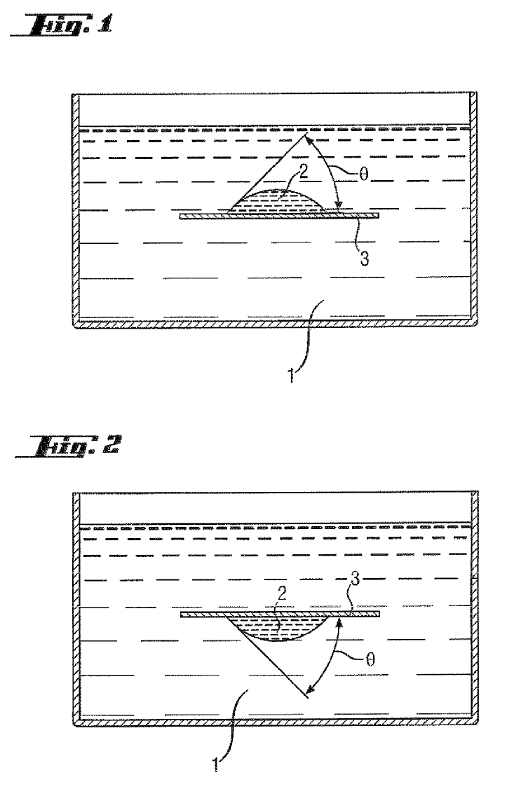

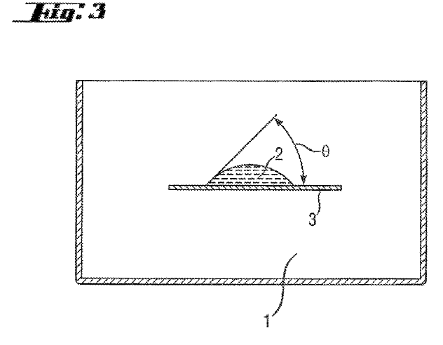

Contact angle determination is already known. The contact angle θ of a fluid phase (2) is measured on a solid phase (3) with a second fluid phase (1) as the surrounding phase (see FIG. 1 and FIG. 2). On this subject, reference is made, for example, to “Wettability” edited by John C. Berg, Surfactant Series volume 49; Marcell Dekker Inc. 1993 ISBN 0-8247-9046-4, chapter 5 T. D. Blake: “Dynamic Contact Angles and Wetting Kinetics”, especially on p. 252 paragraph 1 and FIG. 1b.

Preferably, the contact angle of component (A) with respect to component (B), i.e. the angle that a droplet of component (A) forms on the surface of component (B) with water as the surrounding phase, is determined with the aid of pressed samples (method 1). To this end, a stainless steel cylinder is filled with component (B) and pressed with a polished stainless steel plunger with a pressure of at least 10 MPa, preferably from 50 to 100 MPa. The tableted pressed sample thus produced is introduced horizontally into a water-filled vessel. A droplet of component (A) is then applied on a horizontal surface of the pressed sample. When component (A) is heavier than water, the droplet is applied from above to the upper surface of the pressed sample (FIG. 1); when component (A) is lighter than water, it is applied to the lower surface of the pressed sample (FIG. 2). The angle formed by the tangent applied at the three-phase point at the droplet/surrounding phase interface with respect to the droplet/solid phase interface is suitably measured especially with a goniometer.

The contact angle of component (A) with respect to component (B) can also be measured by applying a droplet of component (A) to a surface chemically identical to component (B). For example, when pyrogenic silica (SiO₂) is used as component (B), a quartz glass surface can be used. When the surface of this silica has been modified, the measurement should be carried out on a quartz glass surface which has likewise been modified (method 2).

The inventive compositions comprise, as component (A), preferably a mixture of siloxanes (A1) and (A2), and, based in each case on 100 parts by weight of (A1), more preferably 0.1 to 100 parts by weight, especially 1 to 20 parts by weight, of (A2) are used.

Examples of the R radical are the hydrogen atom, alkyl radicals such as the methyl, ethyl, n-propyl, isopropyl, n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical, the isooctyl radical and the 2,2,4-trimethylpentyl radical, nonyl radicals such as the n-nonyl radical, decyl radicals such as the n-decyl radical, dodecyl radicals such as the n-dodecyl radical; alkenyl radicals such as the vinyl and allyl radical; cycloalkyl radicals such as norbornyl, cyclo-pentyl, cyclohexyl, cycloheptyl radicals and methyl-cyclohexyl radicals; aryl radicals such as the phenyl radical and the naphthyl radical; alkaryl radicals such as o-, m-, p-tolyl radicals, xylyl radicals and ethyl-phenyl radicals; aralkyl radicals such as the benzyl radical, the α- and the β-phenylethyl radical, and the 2-propenylphenyl radical.

Preferably less than 5%, especially less than 1%, of all R radicals in the organopolysiloxanes (A) are defined as a hydrogen atom.

Examples of substituted R radicals are 3,3,3-trifluoro-n-propyl radical, cyanoethyl, glycidoxypropyl, polyalkylene glycol propyl, aminopropyl, aminoethyl-aminopropyl, methacryloyloxypropyl radicals.

The R radical is preferably a hydrogen atom or hydro-carbon radicals which are optionally substituted by halogen atoms, hydroxyl groups, polyether groups, mercapto groups, acrylate groups, methacrylate groups, epoxy groups, cyano groups, amino groups and have from 1 to 30 carbon atoms, more preferably alkyl groups having from 1 to 20 carbon atoms, cycloalkyl groups having from 5 to 10 carbon atoms, phenyl groups or alkylaryl groups, for example 2-phenylpropyl groups, especially methyl, ethyl, octyl, phenyl, 2-phenylpropyl groups.

Examples of R¹ radicals are the radicals mentioned as the R radicals.

The R¹ radical is preferably a hydrogen atom or hydro-carbon radicals which are optionally substituted by halogen atoms, hydroxyl groups, polyether groups, mercapto groups, acrylate groups, methacrylate groups, epoxy groups, cyano groups, amino groups and have from 1 to 30 carbon atoms, more preferably a hydrogen atom or hydrocarbon radicals having from 1 to 4 carbon atoms, especially methyl or ethyl radicals.

B is preferably 0 or 1, more preferably 0.

Component (A1) preferably comprises branched or linear organopolysiloxanes.

The component (A1) used in accordance with the invention preferably essentially comprises linear organopolysiloxanes of the formula

R₃Si—(O—SiR₂)ₙO—SiR₃ (IV)

where R radicals have one of the definitions given above and the index n, which determines the degree of polymerization of the polysiloxane (IV) and hence the viscosity, is in the range from 1 to 10 000, preferably in the range from 2 to 1000, more preferably in the range from 10 to 200.

Although it is not stated in formula (IV), these organopolysiloxanes may contain up to 10 mol percent, based on the sum of all siloxane units, of other siloxane units such as SiO_{3/2} and SiO_{4/2} units.

The organosilicon compounds (A1) used in the inventive compositions have a viscosity of preferably from 5 to 5 000 000 mPas, more preferably from 50 to 50 000 mPas, especially from 200 to 15 000 mPas, in each case measured at 25° C.

The organosilicon compounds (A1) can be prepared by any methods known to date in organosilicon chemistry, for example by cohydrolysis of the corresponding silanes.

Such processes are known to those skilled in the art. Especially organopolysiloxanes with alkyl groups which contain more than one carbon atom or with aralkyl groups are, as is well known, preferably prepared by a hydrosilylation reaction of the corresponding organo-silicon compounds containing Si-bonded hydrogen with olefins. In the hydrosilylation, organosilicon compounds with Si-bonded hydrogen (1) are reacted by known processes with the corresponding aliphatically unsaturated compounds (2), for example ethylene, propylene, 1-hexene, 1-octene, 1-dodecene, 1-hexadecene and 1-octadecene, in the presence of catalysts (3) which promote the addition of Si-bonded hydrogen onto aliphatic multiple bonds (hydrosilylation), for example metals from the group of the platinum metals or compounds or complexes from the group of the platinum metals.

Examples of R² radicals in component (A2) are the radicals specified for R radicals.

The R² radicals are preferably hydrocarbon radicals which are optionally substituted by halogen atoms, hydroxyl groups, polyether groups, mercapto groups, acrylate groups, methacrylate groups, epoxy groups, cyano groups, amino groups and have from 1 to 30 carbon atoms, more preferably hydrocarbon radicals having from 1 to 6 carbon atoms, especially the methyl radical.

Examples of the R³ radicals are the radicals specified for the R¹ radical.

The R³ radical is preferably a hydrogen atom or hydrocarbon radicals having from 1 to 4 carbon atoms, especially the hydrogen atom, methyl or ethyl radicals.

The value for c is preferably equal to 3 or 0.

The value for d is preferably equal to 0 or 1.

The component (A2) optionally used in accordance with the invention preferably comprises silicone resins in which the sum of c+d is equal to 2 in less than 30%, more preferably in less than 5%, of all units of the formula (II).

Component (A2) more preferably comprises organopoly-siloxane resins which consist essentially of R²₃SiO_{1/2} (M) and SiO_{4/2} (O) units where R² is as defined above; these resins are also referred to as MQ resins. The molar ratio of M to Q units is preferably in the range from 0.5 to 2.0, more preferably in the range from 0.6 to 1.0. These silicone resins may also contain up to 10% by weight of free hydroxyl or alkoxy groups.

These organopolysiloxane resins (A2) preferably have a viscosity greater than 1000 mPas at 25° C. or are solids. The weight-average molecular weight determined by gel permeation chromatography (based on a polystyrene standard) of the resins (A2) is preferably from 200 to 200 000 g/mol, especially from 1000 to 20 000 g/mol.

Components (A2) are commercial products or can be prepared by processes common in silicon chemistry, for example according to “Parsonage, J. R.; Kendrick, D. A. (Science of Materials and Polymers Group, University of Greenwich, London, UK SE18 6 PF) Spec. Publ.—R. Soc. Chem. 166, 98-106, 1995”, U.S. Pat. No. 2,676,182 or EP-A 927 733.

Component (B) preferably comprises pulverulent, preferably hydrophobic, fillers.

Examples of component (B) are silicon dioxide (silicas), titanium dioxide, aluminum oxide, metal soaps, quartz flour, PTFE powder, fatty acid amides, e.g. ethylenebisstearamide, finely divided hydrophobic polyurethanes, preference being given to silicon dioxide (silicas), titanium dioxide and aluminum oxide.

Component (B) preferably has a BET surface area of from 20 to 1000 m²/g, more preferably from 50 to 800 m²/g, especially from 80 to 500 m²/g.

Component (B) preferably has a particle size of less than 10 μm, more preferably from 0.01 to 5 μm.

Component (B) preferably has an agglomerate size of less than 100 μm, more preferably from 0.1 to 10 μm.

Particularly preferred components (B) are silicas, especially those having a BET surface area of from 50 to 800 m²/g. These silicas may be pyrogenic or precipitated silicas. As component (B), it is possible to use either pretreated silicas, i.e. commercial hydrophobic silicas, or hydrophilic silicas. Examples of commercially available hydrophobic silicas which can be used in accordance with the invention are a pyrogenic silica which has been treated with hexamethyldisilazanes and has a BET surface area of 140 m²/g (commercially available under the brand HDK® H2000 from Wacker-Chemie GmbH, Germany) and a precipitated silica which has been treated with poly-dimethylsiloxane and has a BET surface area of 90 m²/g (commercially available under the name Sipernat® D10 from Degussa AG, Germany).

If the components (B) used are to be hydrophobic silicas, hydrophilic silicas can also be hydrophobized in situ if this is advantageous for the desired activity of the defoamer formulation. Many processes for hydrophobizing silicas are known. The in situ hydrophobization of the hydrophilic silica can be effected, for example, by heating the silica dispersed in component (A) to temperatures of from 100 to 200° C. over several hours. The reaction can be promoted by the addition of catalysts such as KOH and of hydrophobizing agents such as short-chain OH-terminated polydimethylsiloxanes, silanes or silazanes. This treatment is also possible when commercial hydrophobic silicas are used.

A further possibility is the use of a combination of silicas hydrophobized in situ with commercial hydro-phobic silicas.

Preference is given to using, as silica (B), surface-modified silicas, especially silicas modified with organosilicon compounds.

What is essential in the selection of component (B), depending on component (A), is, however, that the contact angle with respect to component (A) is less than 40°.

The inventive compositions comprise component (B) in amounts of preferably from 0.1 to 30 parts by weight, more preferably from 1 to 15 parts by weight, especially from 2 to 10 parts by weight, based in each case on 100 parts by weight of (A).

Apart from components (A) and (B), the inventive compositions may comprise all further substances as have also been used to date in defoamer formulations, for example water-insoluble organic compounds (C).

In the context of the present invention, the term “water-insoluble” shall be understood to mean a solubility in water at 25° C. and a pressure of the surrounding atmosphere, i.e. between 900 and 1100 hPa, of not more than 3 percent by weight.

The optionally used component (C) preferably comprises water-insoluble organic compounds having a boiling point greater than 100° C. at the pressure of the surrounding atmosphere, i.e. at from 900 to 1100 hPa, especially those selected from mineral oils, native oils, isoparaffins, polyisobutylenes, residues from the oxo alcohol synthesis, esters of low molecular weight synthetic carboxylic acids, fatty acid esters, for example octyl stearate, dodecyl palmitate, fatty alcohols, ethers of low molecular weight alcohols, phthalates, esters of phosphoric acid and waxes.

The inventive compositions comprise water-insoluble organic compounds (C) in amounts of preferably from 0 to 1000 parts by weight, more preferably from 0 to 100 parts by weight, based in each case on 100 parts by weight of the total weight of components (A) and (B).

The components used in accordance with the invention may each be one kind of such a component or a mixture of at least two types of a particular component.

The inventive compositions are more preferably those which comprise component (A1), component (A2), component (B) and optionally component (C), where the contact angle of component (A) with respect to component (B), measured with water as the surrounding phase, is less than 40°.

Even more preferably, the inventive compositions are those which comprise

100 parts by weight of component (A1),
from 1 to 20 parts by weight of component (A2),
from 1 to 20 parts by weight of component (B) and optionally
from 0 to 1000 parts by weight of water-insoluble organic compound (C),
where the contact angle of component (A) relative to component (B), measured with water as the surrounding phase, is less than 40°.

In particular, the inventive compositions are those which consist of

100 parts by weight of component (A1),
from 1 to 20 parts by weight of component (A2),
from 1 to 20 parts by weight of fumed silica as component (B) and optionally
(C) water-insoluble organic compound,
where the contact angle of component (A) relative to component (B), measured with water as the surrounding phase, is less than 30°.

The inventive compositions are preferably viscous, clear to opaque, colorless to brownish liquids.

The inventive compositions have a viscosity of preferably from 100 to 10 000 000 mPas, more preferably from 500 to 50 000 mPas, especially from 1000 to 10 000 mPas, in each case at 25° C.

The inventive compositions may—if desired—be processed further to emulsions or powders.

The inventive compositions can be produced by known processes, for example by mixing all components, for example employing high shear forces in colloid mills, dissolvers or rotor-stator homogenizers. The mixing operation can be effected at reduced pressure in order to prevent the mixing-in of air which is, for example, present in high-dispersity solids. This can be followed, if required, by the in situ hydrophobization of the fillers.

If the inventive compositions are to be processed further to emulsions, it is possible to use all emulsifiers which are known to those skilled in the art for the preparation of silicone emulsions, for example anionic, cationic or nonionic emulsifiers. Preference is given to using emulsifier mixtures wherein at least one nonionic emulsifier, for example sorbitan fatty acid esters, ethoxylated sorbitan fatty acid esters, ethoxylated fatty acids, ethoxylated linear or branched alcohols having from 10 to 20 carbon atoms and/or glyceryl esters, should be present. In addition, the thickeners added may be known compounds such as polyacrylic acid, polyacrylates, cellulose ethers such as carboxymethylcellulose and hydroxyethylcellulose, natural gums such as xanthan gum and polyurethanes, and also preservatives and other customary additives known to those skilled in the art.

The continuous phase of the inventive emulsions is preferably water. However, it is also possible to prepare inventive compositions in the form of emulsions in which the continuous phase is formed by components (A) and (B) or by component (C). The compositions may also be multiple emulsions.

Processes for preparing silicone emulsions are known. Typically, the preparation is effected by simple stirring of all constituents and optionally subsequent homogenization with jet dispersers, rotor-stator homogenizers, colloid mills or high-pressure homogenizers.

If the inventive compositions are emulsions, preference is given to oil-in-water emulsions containing from 5 to 50% by weight of components (A) to (C), from 1 to 20% by weight of emulsifiers and thickeners, and from 30 to 94% by weight of water.

The inventive compositions may also be formulated to form free-flowing powders. These are preferred, for example, in the case of use in pulverulent washing compositions. The production of these powders proceeding from the mixture of components (A), (B) and optionally (C) is effected by processes known to those skilled in the art, such as spray-drying or buildup granulation, and with additives known to those skilled in the art.

The inventive powders preferably contain from 2 to 20% by weight of components (A) to (C). The carriers used are, for example, zeolites, sodium sulfate, cellulose derivatives, urea and sugars. Further constituents of the inventive powders may, for example, be waxes or organic polymers, as described, for example, in EP-A 887097 and EP-A 1060778.

The inventive compositions can be used anywhere where compositions based on organosilicon compounds have also been used to date. More particularly, they can be used as defoamers.

The present invention further provides washing and cleaning compositions comprising the inventive compositions.

The present invention further provides a process for defoaming and/or preventing foam in media, characterized in that the inventive composition is mixed with the medium.

The inventive composition can be added directly to the foaming media, or mixed with suitable solvents such as toluene, xylene, methyl ethyl ketone or t-butanol, as a powder or as an emulsion. The amount needed to achieve the desired defoaming action is guided, for example, by the type of medium, the temperature and the turbulence which occurs.

Preference is given to adding the inventive compositions to the foaming medium in amounts of from 0.1 ppm by weight to 1% by weight, especially in amounts of from 1 to 100 ppm by weight.

The process according to the invention is carried out at temperatures of preferably from −10 to +150° C., more preferably from 5 to 100° C., and the pressure of the surrounding atmosphere, i.e., for instance, from 900 to 1100 hPa. The process according to the invention can also be carried out at higher or lower pressures, for instance at from 3000 to 4000 hPa or from 1 to 10 hPa.

The inventive defoamer compositions can be used anywhere where troublesome foam should be suppressed. This is the case, for example, in nonaqueous systems such as in tar distillation or mineral oil processing. In particular, the inventive compositions are suitable for controlling foam in aqueous surfactant systems, for use in washing and cleaning compositions and for control of foam in wastewater treatment plants. In addition, the inventive compositions are usable in textile dyeing processes, in natural gas scrubbing, in polymer dispersions and for defoaming aqueous media obtained in cellulose production.

The inventive compositions have the advantage that they are easy to handle as defoamers and that they feature a high, long-lasting activity in a wide variety of different media with different added amounts. This is exceptionally advantageous both in economic and ecological terms.

The process according to the invention has the advantage that the selection of suitable combinations of (A) and (B) is reliably appropriate and simple to perform. Complicated performance tests on a multitude of conceivable substance combinations are not required. The process is thus very economically viable.

In the examples which follow, all parts and percentage data, unless stated otherwise, are based on weight. Unless stated otherwise, the examples which follow are carried out at a pressure of the surrounding atmosphere, i.e. at about 1000 hPa, and at room temperature, i.e. about 20° C. or a temperature which is established on combination of the reactants at room temperature without additional heating or cooling. All viscosity data given in the examples should be based on a temperature of 25° C.

### Measuring of the Contact Angle (FIGS. 1 and 2)

### Method 1

20 mm of component (B) are filled into a stainless steel cylinder with a diameter of 13 mm and a height of 40 mm, and pressed with a pressure of 70 MPa with a polished stainless steel plunger. The pressed sample (3) thus produced is introduced horizontally into a glass vessel filled with water (phase 1). On a horizontal surface of the pressed sample, a droplet (phase 2) of component (A) is applied with a Pasteur pipette. When component (A) is heavier than water (1), the droplet (2) is applied to the upper phase of the pressed sample (3) from above (FIG. 1), and, when component (A) is lighter than water, on the lower surface of the pressed sample (FIG. 2). The angle θ formed by the tangent applied at the three-phase point at the droplet/surrounding phase interface with respect to the droplet/solid phase interface is measured with a goniometer. The procedure is repeated several times and the mean value and the scatter (standard deviation) are calculated.

### Method 2

The contact angle of component (A) with respect to component (B) is measured on a quartz glass surface which has optionally been modified analogously to component (B). To this end, a quartz glass pane is introduced horizontally into a glass vessel filled with water. On a horizontal surface of the quartz glass pane, a droplet of component (A) is applied with a Pasteur pipette. When component (A) is heavier than water, the droplet is applied to the upper surface from the top, and, when component (A) is lighter than water, on the lower surface. The angle θ formed by the tangent applied at the three-phase point at the droplet/surrounding phase interface with respect to the droplet/solid phase interface is measured with a goniometer.

The procedure is repeated several times and the mean value and the scatter (standard deviation) are calculated.

In order to show that method 1 and method 2 bring the same results within the error limits, a contact angle measurement was produced with a pressed sample of a fumed silica with a BET surface area of 300 m²/g (commercially available from Wacker-Chemie GmbH, Germany under the name HDK® T30), and the contact angle of an oil with a viscosity of 150 mm²/s, which consists of methylphenylsiloxane and dimethylsiloxane units and is terminated with trimethylsiloxy groups, is determined with water as the surrounding phase. For comparison, the measurement was carried out with a quartz glass pane instead of the pressed sample. The results are shown in table 1.

TABLE 1

| | Contact | Scatter in 6 measurements |
|---|---|---|
| Method | angle θ | (standard deviation) |
| 1 (pressed silica | 148.2° | 2.5° |
| sample) | | |
| 2 (quartz glass) | 144.2° | 2.5° |

In the examples which follow, the contact angles were determined by method 2 on quartz glass plates which had been treated in exactly the same way as the silicas used.

The quartz glass/water contact angle, as a measure of the hydrophobicity of the silica, was determined in an analogous manner with a water droplet (phase 2) and air as the surrounding phase (phase 1) (FIG. 3).

### Tests of the Defoamer Activity

1. Antifoam characteristic AC

In an apparatus corresponding to DE-A 25 51 260, 200 ml of a 4% by weight aqueous solution of a sodium alkyl-sulfonate (Mersolat) which comprises 10 mg of the defoamer to be studied (dissolved in 10 times the amount of methyl ethyl ketone) is foamed with two contrarotatory stirrers for 1 minute. Subsequently, the foam decay is recorded. From the area of the plot of foam height against time, the antifoam characteristic is calculated. The lower this number is, the more effective is the defoamer.

### 2. Stirring Test

300 ml of a solution which contains 1% by weight of a defoamer-free washing powder were foamed with a stirrer at a speed of 1000 revolutions/min for 5 minutes. Subsequently, 100 μl of a 10% by weight solution of the defoamer in methyl ethyl ketone were added, and the stirring was continued for a further 25 minutes. During the whole time, the foam height is recorded.

As a measure of the activity, the average foam height is calculated based on the foam height without defoamer after 2-3 minutes. The lower this value is, the more effective is the defoamer.

3. Test in a Washing Machine with a Pulverulent Washing Composition

0.1 g of defoamer is added to 100 g of the defoamer-free washing powder. The washing powder was then added together with 3500 g of clean cotton laundry to a drum washing machine (Miele Novotronik W918 without fuzzy logic). Subsequently, the wash program is started and the foam height is recorded over a period of 55 minutes. From the foam marks determined over the entire duration (0 no foam measurable to 6 over-foaming), the average foam mark is determined. The lower this is, the more effective is the defoamer over the whole duration.

### EXAMPLE 1

85 parts of a silicone oil (A1-1) with a viscosity of 1000 mm²/s, which consists of methylphenylsiloxane and dimethylsiloxane units and is terminated with trimethylsiloxy groups, 5 parts of a room temperature solid silicone resin (A2-1) composed of trimethylsiloxy and SiO₂ units in a molar ratio of 0.61/1 with a weight-average molar mass of 5728 g/mol (based on polystyrene standard) and a content of Si-bonded hydroxyl groups of 0.8% by weight, dissolved in 5 parts of a hydrocarbon mixture (C-1) with a boiling range of 235-270° C. (commercially available under the name Exxsol D 100 S from Staub & Co, Nuremberg, Germany), 5 parts of a fumed silica (B-1) having a BET surface area of 400 m²/g (commercially available from Wacker-Chemie GmbH, Germany under the name HDK® T40) and 0.7 part of 20% by weight methanolic KOH are mixed with a dissolver and heated to 150° C. for 4 hours. A defoamer having a viscosity of 4800 mPas was obtained. The composition thus obtained was then analyzed with respect to the antifoam characteristic AC, the stirring test and the test in the washing machine.

To measure the contact angle, a quartz glass pane is immersed into the abovementioned mixture of (A1-1) and (A2-1) and the catalyst, and likewise heated to 150° C. for 4 hours. After cooling and runoff (vertical storage for 24 hours) of the free siloxane, the glass is immersed into water and a droplet of the above-described mixture of (A1-1) and (A2-1) is introduced onto the surface in order to determine the contact angle. The results of these tests are compiled in table 2.

### EXAMPLE 2

90 parts of a silicone oil (A1-2) of the formula Me₃Si—O—[SiMeOct-O—]₂₀—SiMe₃ (Oct represents an octyl radical, Me a methyl radical) with a viscosity of 221 mPas, 5 parts of a room temperature solid silicone resin (A2-2) composed of trimethylsiloxy and SiO₂ units in a molar ratio of 0.61/1 with a weight-average molar mass of 5728 g/mol (based on polystyrene standard) and a content of Si-bonded hydroxyl groups of 0.8% by weight, 5 parts of a fumed silica (B-2) having a BET surface area of 300 m²/g (commercially available from Wacker-Chemie GmbH, Germany under the name HDK® T30), and 0.7 part of 20% by weight methanolic KOH are mixed with a dissolver and heated to 150° C. for 4 hours. A defoamer with a viscosity of 1800 mPas was obtained. The composition thus obtained was tested with respect to the antifoam characteristic AC, the stirring test and the test in the washing machine.

To measure the contact angle, a quartz glass pane is heated with the abovementioned mixture of (A1-2) and (A2-2) and the catalyst, likewise to 150° C. for 4 hours. After cooling and runoff (vertical storage for 24 hours) of the free siloxane, the glass is immersed into water and a droplet of the above-described mixture of (A1-2) and (A2-2) is introduced onto the surface in order to determine the contact angle.

The results of these tests are compiled in table 2.

### EXAMPLE 3

90 parts of a polydimethylsiloxane (A1-3) with a viscosity of 8000 mm²/s, 5 parts of a room temperature solid silicone resin (A2-3) consisting, according to ²⁹Si NMR and IR analysis, of 90.7 mol % of CH₃SiO_{3/2} units, 4.3 mol % of C₂H₅—O—(CH₃) SiO_{2/2} units, 4 mol % of HO(CH₃)SiO_{2/2} units and 1 mol % of (CH₃)₂SiO_{2/2} units with a weight-average molar mass of 10 710 g/mol (based on polystyrene standard), 5 parts of a fumed silica (B-3) with a BET surface area of 400 m²/g (commercially available from Wacker-Chemie GmbH, Germany under the name HDK® T40) and 0.7 part of 20% by weight methanolic KOH are mixed with a dissolver and heated to 150° C. for 4 hours. A defoamer with a viscosity of 6400 mPas was obtained. The composition thus obtained was tested with respect to the antifoam characteristic AC, the stirring test and the test in the washing machine.

To measure the contact angle, a quartz glass pane is heated with the abovementioned mixture of (A1-3) and (A2-3) and the catalyst, likewise to 150° C. for 4 hours. After cooling and runoff (vertical storage for 24 hours) of the free siloxane, the glass is immersed into water and a droplet of the above-described mixture of (A1-3) and (A2-3) is introduced onto the surface in order to determine the contact angle.

The results of these tests are compiled in table 2.

### COMPARATIVE EXAMPLE 1

95 parts of a silicone oil (A1-C1) with a viscosity of 1000 mm²/s, which consists of methylphenylsiloxane and dimethylsiloxane units and is terminated with trimethylsiloxy groups, 5 parts of a fumed silica (B-C1) with a BET surface area of 400 m²/g (commercially available from Wacker-Chemie GmbH, Germany under the name HDK® T40) and 0.7 part of 20% by weight methanolic KOH are mixed with a dissolver and heated to 150° C. for 4 hours. An opaque mixture with a viscosity of 30 400 mPas was obtained. The composition thus obtained was then tested with respect to the antifoam characteristic AC, the stirring test and the test in the washing machine.

To measure the contact angle, a quartz glass pane is heated with the abovementioned polysiloxane (A1-C1) and the catalyst, likewise to 150° C. for 4 hours. After cooling and runoff (vertical storage for 24 hours) of the free siloxane, the glass is immersed into water and a droplet of (A1-C1) is introduced onto the surface in order to determine the contact angle.

### COMPARATIVE EXAMPLE 2

90 parts of a polydimethylsiloxane (A1-C2) with a viscosity of 350 mm²/s, 5 parts of a room temperature solid silicone resin (A2-C2) composed of trimethyl-siloxy and SiO₂ units in a molar ratio of 0.61/1 with a weight-average molar mass of 5728 g/mol (based on polystyrene standard) and a content of silicon-bonded hydroxyl groups of 0.8% by weight, dissolved in 5 parts of a hydrocarbon mixture (C-C2) with a boiling range of 235-270° C. (commercially available under the name Exxsol D 100 S from Staub & Co, Nuremberg, Germany), 5 parts of a fumed silica (B-C2) having a BET surface area of 200 m²/g (commercially available from Wacker-Chemie GmbH, Germany under the name HDK® N20) are mixed with a dissolver. A defoamer with a viscosity of 2556 mPas was obtained. The composition thus obtained was then tested with respect to the antifoam characteristic AC, the stirring test and the test in the washing machine.

To measure the contact angle, a quartz glass pane is immersed into water and a droplet of the mixture of A1 and A2 is introduced onto the surface in order to determine the contact angle.

The results of these tests are compiled in table 2.

TABLE 2

| | Contact | Glass/water | | | Average |
|---|---|---|---|---|---|
| | angle | contact | | Stirring | foam |
| Example | θ | angle | AC | test in % | mark |
| 1 | 20.1° ± 4.4° | 85.5° ± 0.7° | 122 | 58 | 1.5¹⁾ |
| | | | | | 1.8²⁾ |
| 2 | 8.4° ± 1.4° | 90.2° ± 0.4° | 95 | 50 | 0.3 |
| 3 | 10.1° ± 1.2° | 94.8° ± 2.0 | 720 | 68 | 2.2 |
| C1 | 69.8° ± 27.1° | 81.9° ± 3.2° | 6000 | 100 | 6 |
| C2 | 162.2 ± 1.5 | 5.8° ± 0.7 | 4150 | 95 | 5.8 |

In comparative tests C1 and C2, there was very rapid overflow of the foam liquor.

It is clear that, although a virtually equal contact angle to water (i.e. hydrophobicity) has been achieved in the examples, the inventive compositions have a superior activity.

1-10. (canceled)

11. A composition comprising at least one carrier oil and at least one particulate filler, wherein the contact angle of the carrier oil with respect to the filler, measured with water as the surrounding phase, is less than 40°.

12. The composition of claim 11, comprising (A) at least one of organosilicon compounds A1 and A2: (A1) organopolysiloxanes comprising units of the formula
Rₐ(R¹O)_{b}SiO_{(4-a-b)/2} (I)
in which
R each is the same or different and is a hydrogen atom or a monovalent, optionally substituted, SiC-bonded hydrocarbon radical,
R¹ each is the same or different and is a hydrogen atom or a monovalent, optionally substituted hydrocarbon radical,
a is 0, 1, 2 or 3,
b is 0, 1, 2 or 3,
with the proviso that the sum of a+b is <3 and the sum of a+b in at least 50% of all units of the formula (I) in the organosilicon compound (A1) is equal to 2,
and
(A2) organopolysiloxane resins comprising units of the formula
R²_{c}(R³O)_{d}SiO_{(4-c-d)/2} (II)
in which
R² each is the same or different and is a hydrogen atom or a monovalent, optionally substituted, SiC-bonded hydrocarbon radical,
R³ each is the same or different and is a hydrogen atom or a monovalent, optionally substituted hydrocarbon radical,
c is 0, 1, 2 or 3 and
d is 0, 1, 2 or 3,
with the proviso that the sum of c+d is <3, and the sum of c+d in less than 50% of all units of the formula (II) in the organopolysiloxane resin (A2) is equal to 2,
where component (A) has a viscosity at 25° C. of 5 to 5,000,000 mm²/s,
and
(B) at least one particulate filler,
with the proviso that the contact angle of component (A) relative to component (B), measured with water as the surrounding phase, is less than 40°.

13. The composition of claim 11, comprising, as component (A), a mixture of siloxanes (A1) and (A2).

14. The composition of claim 11, wherein the contact angle of component (A) with respect to component (B) is less than 20°.

15. The composition of claim 11, wherein component (A2) comprises organopolysiloxane resins which consist essentially of R²₃SiO_{1/2} (M) and SiO_{4/2} (O) units where R² is as defined above.

16. The composition of claim 11, wherein component (B) comprises silicon dioxide (silicas), titanium dioxide, aluminum oxide, or a mixture thereof.

17. The composition of claim 11, wherein component (B) comprises silicon dioxide.

18. The composition of claim 11, further comprising at least one additional ingredient which makes the composition suitable for washing and/or cleaning.

19. The composition of claim 11, which is a laundry detergent or dishwasher detergent.

20. A process for defoaming and/or preventing foam in media, comprising adding a composition of claim 11 to the medium.

21. The process of claim 20, wherein the composition is added to the foaming medium in amounts of from 0.1 ppm by weight to 1% by weight.
